(19) United States
(12) Patent Application Publication
(10) Pub. No.: US 2015/0346080 A1
(43) Pub. Date: Dec. 3, 2015

(54) CUVETTE AND AUTOMATIC ANALYZER

(71) Applicants: KABUSHIKI KAISHA TOSHIBA, Minato-ku (JP); TOSHIBA MEDICAL SYSTEMS CORPORATION, Otawara-shi (JP)

(72) Inventors: Kei MASUNISHI, Kawasaki (JP); Naru Ikeda, Tokyo (JP); Shoichi Kanayama, Otawara (JP); Tomohiro Sugimura, Otawara (JP)

(73) Assignees: KABUSHIKI KAISHA TOSHIBA, Minato-ku (JP); TOSHIBA MEDICAL SYSTEMS CORPORATION, Otawara-shi (JP)

(21) Appl. No.: 14/725,333

(22) Filed: May 29, 2015

(30) Foreign Application Priority Data
May 30, 2014 (JP) 2014-111886

(51) Int. Cl. G01N 21/03; G01N 21/51; G01N 21/59

(52) U.S. Cl. CPC G01N 21/03; G01N 21/59; G01N 21/51; G01N 2021/0325; G01N 2021/0378; G01N 2021/513

(57) ABSTRACT

According to one embodiment, cuvette has a bottom wall and a side wall. The bottom wall has a bottom surface. The side wall is connected to the bottom wall so as to surround the bottom surface. The inner surface of the side wall is alternately provided, in the long axis direction of the side wall, with first contact angle regions, each having a first contact angle with respect to a liquid, and second contact angle regions, each having a second contact angle larger than the first contact angle.

### CROSS-REFERENCE TO RELATED APPLICATIONS

This application is based upon and claims the benefit of priority from the prior Japanese Patent Application No. 2014-111886, filed May 30, 2014 the entire contents of which are incorporated herein by reference.

### FIELD

Embodiments described herein relate generally to a cuvette and an automatic analyzer.

### BACKGROUND

An automatic analyzer for medical diagnosis automatically and quantitatively measures serum components concerning many items which are contained in a biological sample such as blood. This apparatus is widely used for clinical examination. The automatic analyzer discharges a serum sample and a reagent into a cuvette, stirs the serum sample and the reagent in the cuvette, and optically performs colorimetric measurement of the liquid mixture of the serum sample and the reagent. At this time, it is necessary to uniformly stir the serum sample and the reagent in the shortest time as possible. The establishment of an effective stirring means for this purpose influences the performance of the apparatus.

Each cuvette used in the automatic analyzer is a small rectangular cuvette having a volume of several hundred μL. A material for a cuvette for optical measurement, a glass material such as synthetic quartz is generally used. Various studies have been made on methods of efficiently stirring a sample and a reagent in this minute cuvette. A glass cuvette having a hydrophilic surface suffers from the solution creeping phenomenon that a liquid in a corner portion of the cuvette rises toward the opening of the cuvette by a capillary action. This causes faulty stirring of the sample and the reagent contained in the cuvette.

### BRIEF DESCRIPTION OF THE VIEWS OF THE DRAWING

FIG. 1 is a view showing the arrangement of an automatic analyzer according to an embodiment;

FIG. 2 is a partially cutaway schematic view of a housing when the stirring bar of a stirring unit in FIG. 1 is viewed from the front side;

FIG. 3 is a schematic sectional view of the stirring bar taken along A-A in FIG. 2;

FIG. 4 is a perspective view showing an example of the outer appearance of a cuvette in FIG. 1;

FIG. 5 is a view schematically showing an example of the positional relationship between the stirring unit and the cuvette in FIG. 1;

FIG. 6 is a view schematically showing the balance between forces acting on a liquid and a solid;

FIG. 7 is a view schematically showing an output image from an optical camera included in a static contact angle measuring apparatus according to this embodiment;

FIG. 8 is a view showing the relationship between hydrophilicity and contact angle;

FIG. 9 is a view showing the relationship between hydrophobicity and contact angle;

FIG. 10 is a view showing an example of a development view of the inner surface of a cuvette 31 according to this embodiment;

FIG. 11 is a plan view of a side wall inner surface of a cuvette according to this embodiment which has a line-and-space pattern;

FIG. 12 is a sectional view of the side wall inner surface taken along the height direction in FIG. 11;

FIG. 13 is a plan view of the side wall inner surface of the cuvette according to this embodiment which has a pillar pattern;

FIG. 14 is a sectional view of the side wall inner surface taken along the height direction in FIG. 13;

FIG. 15A is a schematic plan view of the side wall inner surface in FIG. 10;

FIG. 15B is a schematic sectional view of the side wall inner surface taken along the height direction in FIG. 10;

FIG. 15C is a view showing the contact angle of a liquid adhering to the side wall inner surface in the height direction in FIG. 10;

FIG. 15D is a view showing the contact angle of a liquid adhering to the side wall inner surface in the horizontal direction in FIG. 10;

FIG. 16 is a development view of the inner surface of the cuvette according to application example 1;

FIG. 17 is a development view of the inner surface of the cuvette according to application example 2;

FIG. 18 is a schematic view of one side wall inner surface of the cuvette according to application example 3;

FIG. 19 is a schematic view of one side wall inner surface of the cuvette according to application example 4;

FIG. 20 is a view schematically showing the positional relationship between a light beam emitted from an optical measurement unit and the cuvette according to application example 5;

FIG. 21 is a perspective view of a cuvette according to modification 1;

FIG. 22 is a development view of the inner surface of the cuvette in FIG. 21;

FIG. 23 is a view showing the stirring effect of a cuvette whose entire side wall inner surface exhibits hydrophilicity according to a related art; and

FIG. 24 is a view showing the stirring effect of a cuvette whose entire side wall inner surface exhibits hydrophobicity according to a related art.

### DETAILED DESCRIPTION

In general, according to an embodiment, cuvette has a bottom wall and a side wall. The bottom wall has a bottom surface. The side wall is connected to the bottom wall so as to surround the bottom surface. The inner surface of the side wall is alternately provided, in the long axis direction of the side wall, with first contact angle regions, each having a first contact angle with respect to a liquid, and second contact angle regions, each having a second contact angle larger than the first contact angle.

A cuvette and an automatic analyzer according to this embodiment will be described below with reference to the accompanying drawing.

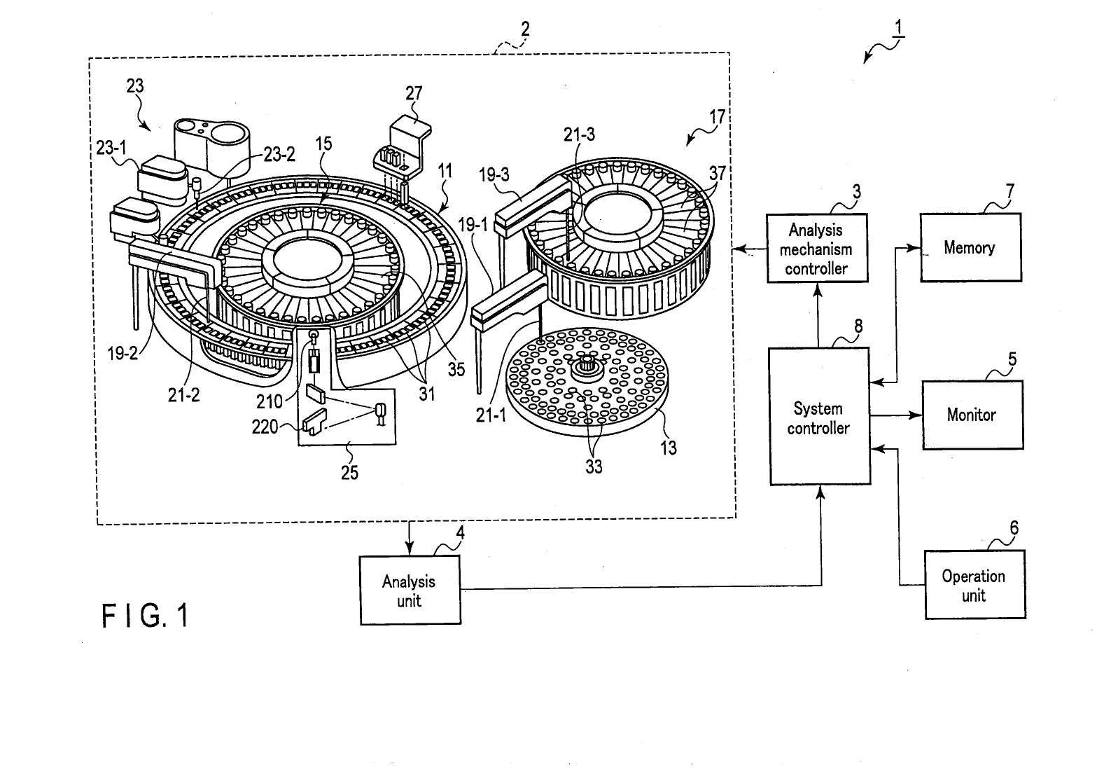

FIG. 1 is a view showing the arrangement of an automatic analyzer 1 according to this embodiment. As shown in FIG. 1, the automatic analyzer 1 includes an analysis mechanism 2, an analysis mechanism controller 3, an analysis unit 4, a monitor 5, an operation unit 6, a memory 7, and a system controller 8.

The analysis mechanism 2 operates under the control of the analysis mechanism controller 3. The analysis mechanism 2 is provided in the housing of the automatic analyzer. For example, as shown in FIG. 1, the analysis mechanism 2 is equipped with a reaction disk 11, a sample disk 13, a first reagent reservoir 15, a second reagent reservoir 17, a sample arm 19-1, a sample probe 21-1, a first reagent arm 19-2, a first reagent probe 21-2, a second reagent arm 19-3, a second reagent probe 21-3, a stirring unit 23, an optical measurement unit 25, and a cleaning unit 27.

The reaction disk (holding mechanism) 11 holds a plurality of cuvettes 31 arrayed on a circumference. The reaction disk 11 alternately and repeatedly pivots and stops at predetermined time intervals. The sample disk 13 is arranged near the reaction disk 11. The sample disk 13 holds sample tubes 33 accommodating samples. The sample disk 13 pivots to locate the sample tube 33 accommodating a dispensing target sample at a sample suction position. The first reagent reservoir 15 holds a plurality of first reagent containers 35 accommodating first reagents which selectively react concerning the measurement items of a sample. The first reagent reservoir 15 pivots to locate the first reagent container 35 accommodating the first reagent as a dispensing target at the first reagent suction position. The second reagent reservoir 17 is arranged near the reaction disk 11. The second reagent reservoir 17 holds a plurality of second reagent containers 37 accommodating second reagents corresponding to the first reagents. The second reagent reservoir 17 pivots to locate the second reagent container 37 accommodating the second reagent as a dispensing target at the second reagent suction position.

The sample arm 19-1 is arranged between the reaction disk 11 and the sample disk 13. The sample probe 21-1 is attached to the distal end of the sample arm 19-1. The sample arm 19-1 supports the sample probe 21-1 so as to allow it to vertically move. The sample arm 19-1 also supports the sample probe 21-1 so as to allow it to pivot along an arcuate pivoting path. The pivoting path of the sample probe 21-1 passes through the sample suction position on the sample disk 13 and the sample discharge position on the reaction disk 11. The sample probe 21-1 sucks a sample from the sample tube 33 arranged at the sample suction position on the sample disk 13, and discharges the sample to the cuvette 31 arranged at the sample discharge position on the reaction disk 11.

The first reagent arm 19-2 is arranged near the outer circumference of the reaction disk 11. The first reagent probe 21-2 is attached to the distal end of the first reagent arm 19-2. The first reagent arm 19-2 supports the first reagent probe 21-2 so as to allow it to vertically move. The first reagent arm 19-2 also supports the first reagent probe 21-2 so as to allow it to pivot along an arcuate pivoting path. The pivoting path of the first reagent probe 21-2 passes through the first reagent suction position on the first reagent reservoir 15 and the first reagent discharge position on the reaction disk 11. The first reagent probe. 21-2 sucks the first reagent from the first reagent container 35 arranged at the first reagent suction position on the first reagent reservoir 15, and discharges the first reagent to the cuvette 31 arranged at the first reagent discharge position on the reaction disk 11.

The second reagent arm 19-3 is arranged between the reaction disk 11 and the second reagent reservoir 17. The second reagent probe 21-3 is attached to the distal end of the second reagent arm 19-3. The second reagent arm 19-3 supports the second reagent probe 21-3 so as to allow it to vertically move. The second reagent arm 19-3 also supports the second reagent probe 21-3 so as to allow it to pivot along an arcuate pivoting path. The pivoting path of the second reagent probe 21-3 passes through the second reagent suction position on the second reagent reservoir 17 and the second reagent discharge position on the reaction disk 11. The second reagent probe 21-3 sucks the second reagent from the second reagent container 37 arranged at the second reagent suction position on the second reagent reservoir 17, and discharges the second reagent to the cuvette 31 arranged at the second reagent discharge position on the reaction disk 11.

A stirring unit 23 is arranged near the outer circumference of the reaction disk 11. A stirring bar holding mechanism (support unit) 23-1 and a stirring bar 23-2 are attached to the stirring unit 23. The stirring bar holding mechanism 23-1 supports the stirring bar 23-2 so as to allow it to vertically move. The stirring bar holding mechanism 23-1 lowers the stirring bar 23-2 into the cuvette 31 arranged at a stirring position on the reaction disk 11. After the stirring bar 23-2 is lowered, the stirring unit 23 vibrates the stirring bar 23-2 to stir the liquid mixture of the sample and the first reagent or the liquid mixture of the sample and the first and second reagents in the cuvette 31. These liquid mixtures will be referred to as reaction liquids.

The optical measurement unit 25 is provided near the reaction disk 11. The optical measurement unit 25 operates under the control of the analysis mechanism controller 3. More specifically, the optical measurement unit 25 includes a light source 210 and a detector 220. The light source 210 generates light. The detector 220 detects the light emitted by the light source and transmitted through the cuvette 31 and the reaction liquid, the light reflected by the cuvette 31 and the reaction liquid, or the light scattered by the cuvette 31 and the reaction liquid. The detector 220 generates data (to be referred to as photometric data hereinafter) representing a measurement value corresponding to the intensity of detected light. The generated photometric data is supplied to the analysis unit 4.

The cleaning unit 27 is provided on the outer circumference of the reaction disk 11. The cleaning unit 27 operates under the control of the analysis mechanism controller 3. More specifically, the cleaning unit 27 includes a cleaning nozzle and a drying nozzle. The cleaning unit 27 cleans the cuvette 31 at a cleaning position of the reaction disk 11 with the cleaning nozzle, and dries the cuvette 31 with the drying nozzle.

The analysis mechanism controller 3 operates the respective apparatuses and mechanisms of the analysis mechanism 2 under the control of the system controller 8. The analysis unit 4 calculates a measurement item value concerning colorimetric measurement of a reaction liquid based on photometric data. More specifically, the analysis unit 4 calculates the absorbance of the reaction liquid based on the photometric data, and calculates a measurement item value based on the calculated absorbance. The monitor 5 includes, for example, a display device such as a CRT display, liquid crystal display, organic EL display, or plasma display. The monitor 5 displays the analysis result such as the measurement item value or the like calculated by the analysis unit 4. The operation unit 6 accepts various types of commands and information inputs from the operator via an input device. As the input device, it is possible to use pointing devices such as a mouse and a trackball, selection devices such as switches and buttons, and input devices such as a keyboard, as needed. The memory 7 stores operation programs and the like for the automatic analyzer 1. The system controller 8 functions as the main unit of the automatic analyzer 1. The system controller 8 reads out operation programs from the memory 7, and controls the units 3, 4, 5, and 7 in accordance with the operation programs.

The stirring unit 23 of the automatic analyzer 1 according to this embodiment will be described next.

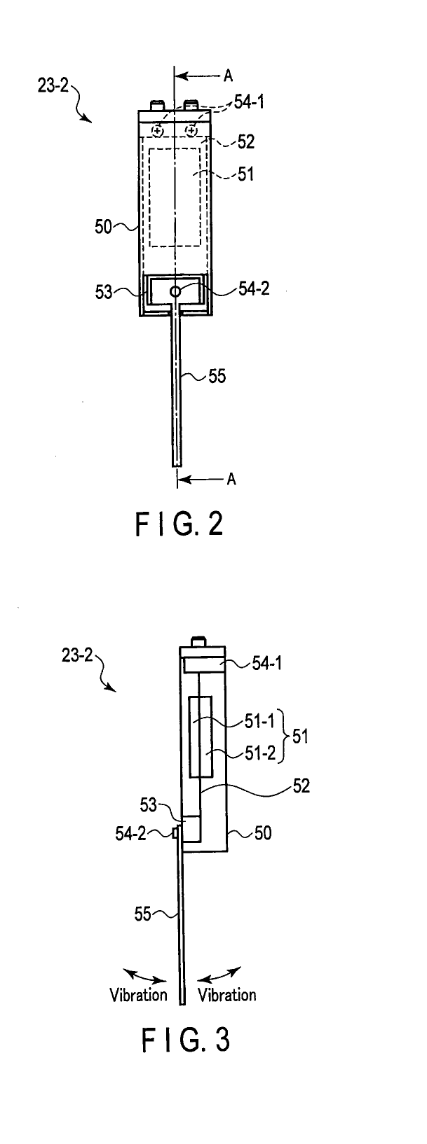

FIG. 2 is a partially cutaway schematic view of the housing when the stirring bar 23-2 of the stirring unit 23 according to this embodiment is viewed from the front side. FIG. 3 is a schematic sectional view of the stirring bar 23-2 taken along A-A in FIG. 2.

As shown in FIGS. 2 and 3, the stirring bar 23-2 includes a housing 50. Vibration units 51, a holding unit 52, and a spacer 53 are housed in the housing 50. Each vibration unit 51 vibrates upon receiving the voltage applied from a power supply unit (not shown). The vibration unit 51 is formed from a piezoelectric vibrator. Each piezoelectric vibrator 51 is formed from, for example, a piezoelectric ceramic element. The holding unit 52 is formed from a thin metal substrate having a flexible structure. The piezoelectric vibrators 51 are respectively bonded to the obverse and reverse surfaces of the holding unit 52. That is, the holding unit 52 is connected to the piezoelectric vibrators. The piezoelectric vibrator 51 bonded to the obverse surface will be referred to as an obverse side vibrator 51-1 hereinafter. The piezoelectric vibrator 51 bonded to the reverse surface will be referred to as a reverse side vibrator 51-2 hereinafter. In this manner, the holding unit 52, the obverse side vibrator 51-1, and the reverse side vibrator 51-2 constitute a bimorph piezoelectric vibrator. One end of the holding unit 52 is fixed to the housing 50 with a fastener 54-1 such as a screw. A blade (stirring rod) 55 coated with a protective coating is attached to the other end of the holding unit 52 through the spacer 53 made of a resin or the like. A notch is formed in the lower end of the housing 50, so that the spacer 53 and the blade 55 are exposed outside. The holding unit 52, the spacer 53, and the blade 55 are integrally fixed at the lower portion of the housing 50 with a fastener 54-2 such as a screw. The blade 55 is a stirring rod for stirring the liquid in the cuvette 31. Typically, the blade 55 and the holding unit 52 are made of the same metal material. The surface of the blade 55 is coated with a protective coating to make the blade 55 endure liquids having various properties in the cuvette 31. As described above, the stirring unit 23 has a bimorph actuator structure with the piezoelectric vibrators 51 being bonded to the obverse and reverse surfaces of the thin metal substrate 52.

The stirring unit 23 is connected to a power supply (not shown) via a cable. The power supply converts an external voltage into an AC voltage and applies the AC voltage to the obverse side vibrator 51-1 and the reverse side vibrator 51-2. Upon receiving the applied AC voltage, the obverse side vibrator 51-1 and the reverse side vibrator 51-2 alternately extend and contract to vibrate the blade 55.

The cuvette 31 according to this embodiment will be described in detail next.

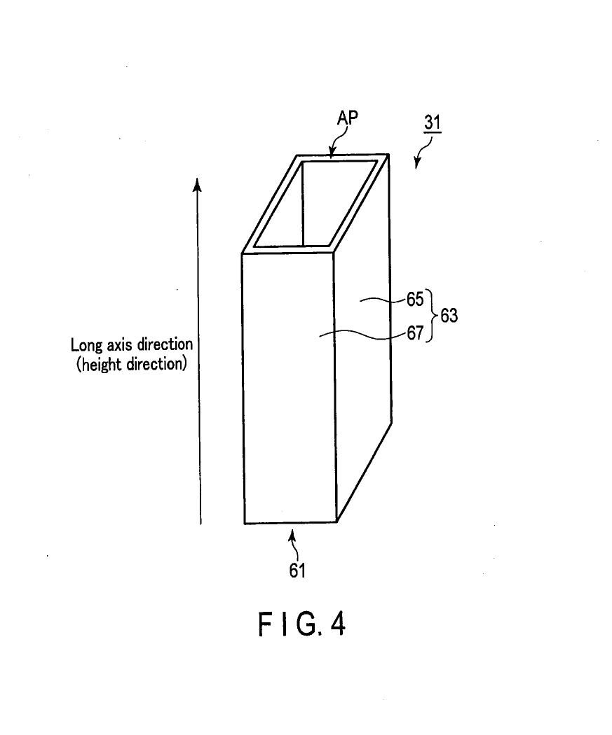

FIG. 4 is a perspective view showing an example of the outer appearance of the cuvette 31 according to this embodiment. As shown in FIG. 4, the cuvette 31 according to this embodiment is a cuvette for accommodating a reaction liquid. The cuvette 31 has a bottom wall 61 having a bottom surface and a side wall 63 connected to the bottom wall 61 so as to surround the bottom surface. The bottom wall 61 is arranged at a position facing an opening AP. The side wall 63 has a rectangular cylindrical shape. The side wall 63 is constituted by four side walls 63 each having a planar shape. The magnitude relationship between the areas of the four side walls 63 can be arbitrarily designed. For example, as shown in FIG. 4, the four side walls 63 are preferably formed into two side walls (to be referred to as large-area side walls hereinafter) 65, each having a relatively large area, and two side walls (to be referred to as small-area side walls hereinafter) 67, each having a relatively small area. The large-area side walls 65 and the small-area side walls 67 will be simply referred to as the side walls 63 hereinafter when they are not discriminated from each other. The cuvette 31 can be formed from an arbitrary material having light transmittance. A direction along the long axis of the cuvette 31 will be referred to as a height direction hereinafter.

FIG. 5 is a schematic view showing an example of the positional relationship between the stirring unit 23 and the cuvette 31. As shown in FIG. 5, when the reaction disk 11 arranges the cuvette 31 at the stirring position, the stirring unit 23 inserts the blade 55 into the cuvette 31 and vibrates the blade 55. The blade 55 vibrates such that the distal end performs a reciprocating motion. Vibrating the blade 55 will stir the sample and the reagent contained in the cuvette 31. After the stirring, as described above, the optical measurement unit 25 optically measures the components of the reaction liquid. The direction in which the distal end of the blade 55 performs a reciprocating motion will be referred to as a vibrating direction hereafter. The direction of the cuvette 31 with respect to the vibrating direction can be arbitrarily set. For example, the cuvette 31 is arranged in the reaction disk 11 such that the large-area side walls 65 are perpendicular to the vibrating direction of the blade 55, and the small-area side walls 67 are parallel to the vibrating direction of the blade 55. Note that the direction of the cuvette 31 with respect to the vibrating direction of the blade 55 is not limited to the above direction, and the cuvette 31 may be arranged in the reaction disk 11 such that the large-area side walls 65 are parallel to the vibrating direction of the blade 55, and the small-area side walls 67 are perpendicular to the vibrating direction of the blade 55.

Although described in detail later, hydrophilic regions and hydrophobic regions are provided on the inner surface of the cuvette 31 according to this embodiment in accordance with a predetermined array pattern. The hydrophilic regions are inner surface regions, of the inner surfaces of the cuvette 31, which exhibit hydrophilicity. The hydrophobic regions are inner surface regions, of the inner surfaces of the cuvette 31, which exhibit hydrophobicity. Assume that in this embodiment, hydrophilicity and hydrophobicity are defined with reference to contact angles. A contact angle is defined by the angle formed by the liquid level of a liquid adhering to an object and the solid surface of the object.

Measurement of the contact angle of a liquid will be described below. A contact angle can be measured by, for example, a static contact angle measuring apparatus. The static contact angle measuring apparatus optically shoots a liquid at rest on a solid with an optical camera, and measures a contact angle by processing an output image from the optical camera. As a contact angle measurement principle, any existing method may be used. For example, the θ/2 method is preferably used. Measurement of a contact angle by the θ/2 method will be described below.

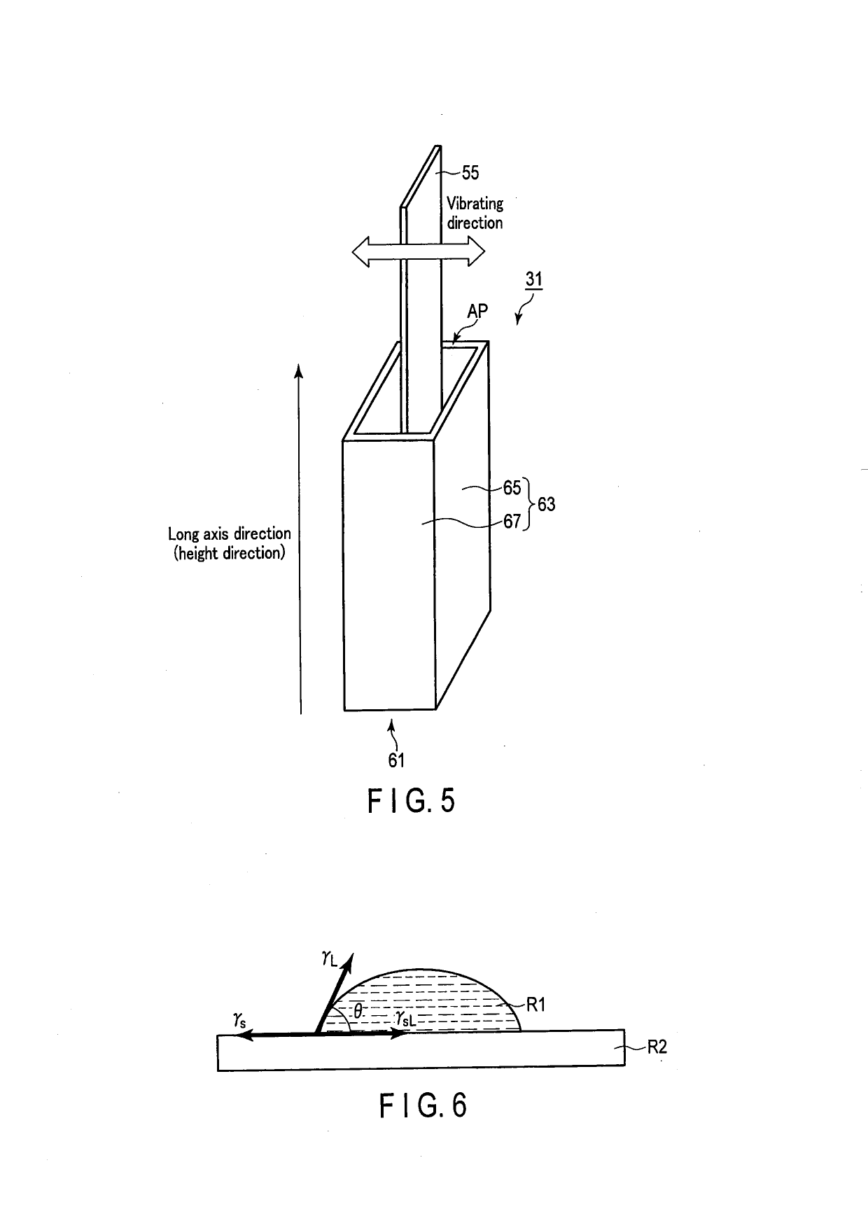

FIG. 6 is a view schematically showing the balance between forces acting on a liquid and a solid. As shown in FIG. 6, forces expressed by the Young's equation as equation (1) are balanced between a solid and a liquid at rest on the solid. Note that in equation (1), γS is the surface tension of the solid, γL is the surface tension of the liquid, γSL is the interfacial tension acting between the surface of the solid and the surface of the liquid, and θ is the contact angle of the liquid to the solid.

γS=γL cos θ+γSL (1)

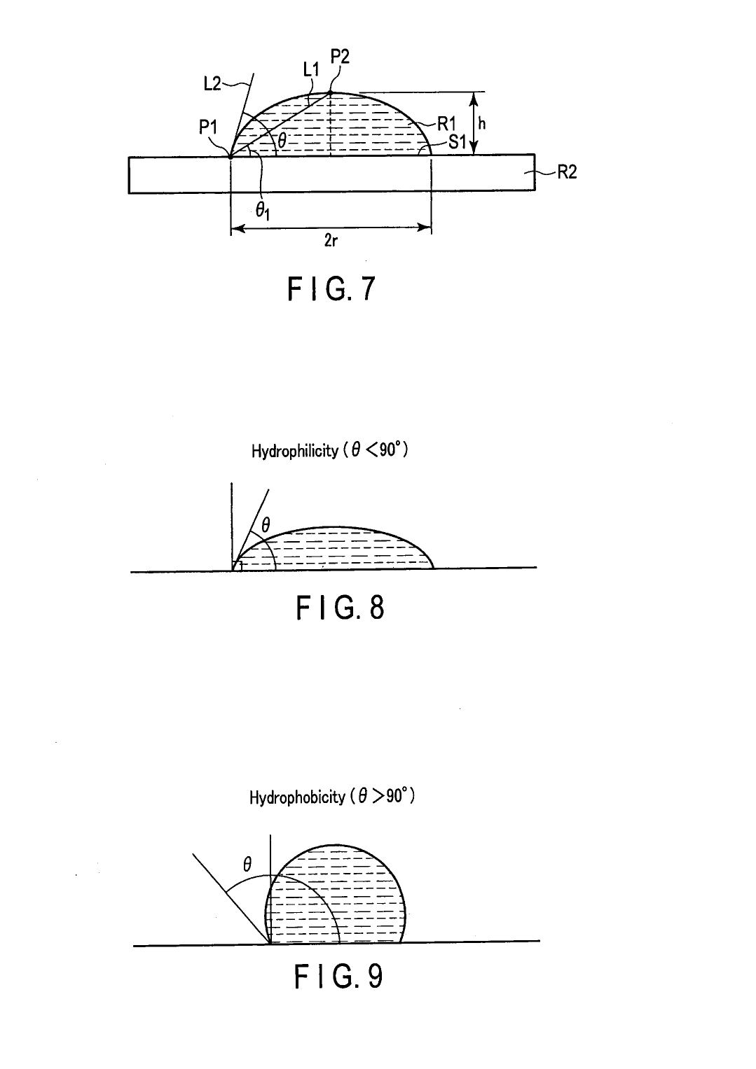

FIG. 7 is a view showing an output image from the optical camera. As shown in FIG. 7, the output image has an image region concerning the liquid (to be referred to as a liquid region hereinafter) R1 and an image region concerning the solid (to be referred to as a solid region hereinafter) R2. Assuming that the shape of the liquid region R1 is part of a circle, equation (2) given below holds according to a geometrical theorem. In this equation, θ1 is the angle formed by a straight line L1 connecting an end point P1 to a vertex P2 of the liquid region R1 and the surface of the solid region R2. The end point P1 is the intersection point between the surface of the liquid region R1 and the surface of the solid region R2.

θ=2·θ1 (2)

Therefore, equation (3) given below holds. In this equation, r is defined by the radius of a contact surface S1 of the liquid region R1, and h is defined by the height of the liquid region R1. More specifically, the radius r is defined by ½ the length of the contact surface S1 of the liquid region R1 with respect to the solid region R2. The height h is defined by the distance between the vertex P2 and the contact surface S1 of the liquid region R1. The static contact angle measuring apparatus calculates the contact angle θ based on the radius r and the height h according to equation (3). More specifically, the static contact angle measuring apparatus specifies the liquid region R1 and the solid region R2 included in an output image by image processing, measures the radius r and the height h based on the liquid region R1 and the solid region R2, and calculates the contact angle θ by substituting the radius r and the height h into equation (3).

$$tan θ 1 = \frac{h}{r} \to θ = 2 {tan}^{- 1} \frac{h}{r} \qquad ( 3 )$$

As a liquid to be used for the measurement of a contact angle, a standard liquid is used, which represents the properties of various types of liquids to be analyzed by the automatic analyzer 1. For example, as this liquid, it is preferable to use water, ion-exchanged water, or glycerin solution. In this embodiment, when a standard liquid is dropped, a solid from which the contact angle θ smaller than a predetermined reference angle is measured is defined as being hydrophilic. When the same type of liquid is dropped, a solid from which the contact angle θ larger than the predetermined reference angle is measured is defined as being hydrophobic. A reference angle can be arbitrarily set in accordance with the properties of a standard liquid. However, in the following description, assume that the reference angle is 90°. That is, in the following embodiment, as shown in FIG. 8, when a standard liquid is dropped, a solid from which the contact angle θ smaller than 90° is measured is defined as being hydrophilic. As shown in FIG. 9, when the standard liquid is dropped, a solid from which the contact angle θ larger than 90° is measured is defined as being hydrophobic. A hydrophilic region according to this embodiment is formed from an object having hydrophilicity, and a hydrophobic region is formed from an object having hydrophobicity.

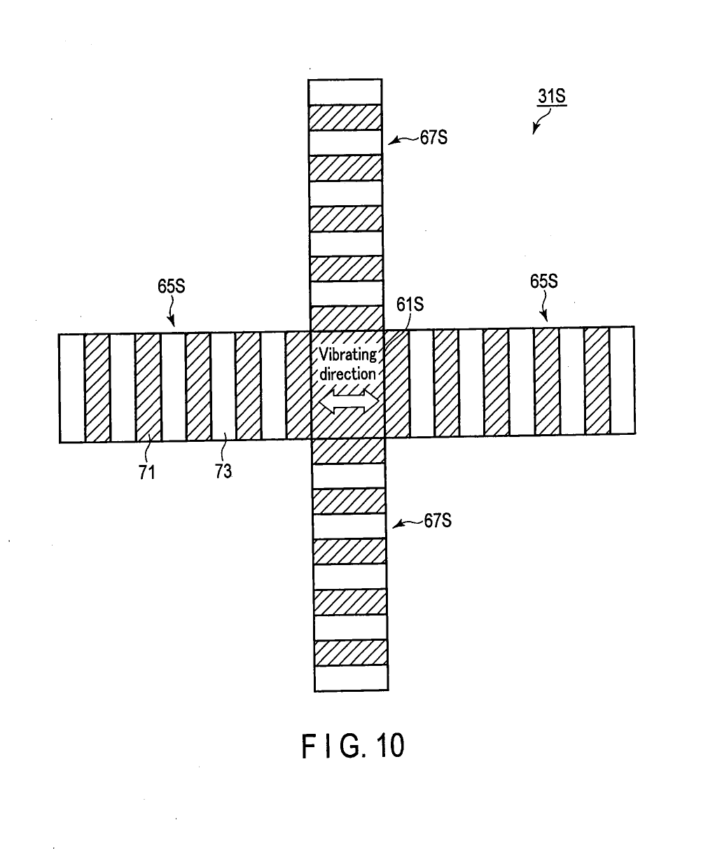

FIG. 10 is a view showing an example of the development view of inner surfaces 31s of the cuvette 31 according to this embodiment. As shown in FIG. 10, hydrophilic regions 71 and hydrophobic regions 73 are alternately provided on the inner surface of each large-area side wall (to be referred to as a large inner surface hereinafter) 65s and the inner surface of each small-area side wall (to be referred to as a small inner surface hereinafter) 67s in the height direction. The hydrophilic regions 71 are regions, of the inner surfaces 31s of the cuvette 31, which exhibit hydrophilicity. The hydrophobic regions 73 are regions, of the inner surfaces 31s of the cuvette 31, which exhibit hydrophobicity. More specifically, the hydrophilic regions 71 and the hydrophobic regions 73 are formed into linear regions (striped regions) each having a predetermined width. Note that the widths of the regions 71 and 73 are defined by the lengths of the regions 71 and 73 in the height direction. Adjusting the widths of the regions 71 and 73 can adjust the center-to-center spacing (pitch) between the adjacent regions 71 and 73. The hydrophilic regions 71 and the hydrophobic regions 73 are formed along a direction parallel to a bottom wall inner surface (to be referred to as a bottom surface hereinafter) 61S, i.e., a direction (to be referred to as a horizontal direction hereinafter) perpendicular to the height direction. The width of each hydrophilic region 71 may be equal to or different from that of each hydrophobic region 73. The width of each of the hydrophilic regions 71 and that of each of the hydrophobic regions 73 can be arbitrarily set.

A method of forming hydrophilic regions and hydrophobic regions will be described below. First of all, the prospective formation regions of hydrophilic regions and the prospective formation regions of hydrophobic regions are positioned. The prospective formation regions of hydrophilic regions and the prospective formation regions of hydrophobic regions are set such that hydrophilic regions and hydrophobic regions are alternatively provided in the height direction. The width and intervals of the prospective formation regions of hydrophilic regions and those of the prospective formation regions of hydrophobic regions can be arbitrarily set.

If, for example, the cuvette 31 is formed from a material exhibiting hydrophilicity (to be referred to as a hydrophilic material hereinafter), only the prospective formation regions of hydrophobic regions of the inner surfaces of the cuvette 31 are coated with a material exhibiting hydrophobicity (to be referred to as a hydrophobic material hereinafter). The prospective formation regions of hydrophilic regions are not coated with a hydrophobic material.

A hydrophilic material used as a material for the cuvette 31 is, for example, silicone dioxide (SiO₂). A hydrophobic material for coating is, for example, a fluorine compound, octadecyltrichlorosilane (OTS), silicone resin, paraffin, or a compound having a hydrophobic group. As a fluorine compound, for example, a compound having a fluoroalkyl chain is used to bond a fluoromethyl group (CF₃) to the terminal of a solid structure. Typically, as a fluorine compound, it is preferable to use Teflon® as a kind of fluorine resin. Octadecyltrichlorosilane is used to form a highly adhesive hydrophobic film on a silicone oxide film. As compound having a hydrophobic group, a compound having a hydrocarbon group (for example, a methyl group, vinyl group, or alkyl group) or a benzene ring is used.

Note that the material for the cuvette 31 need not always have hydrophilicity. In this case, the inner surface of the cuvette 31 may be coated with a hydrophilic material to form hydrophilic regions on the inner surface of the cuvette 31. In this case, as a hydrophilic material for coating, for example, titanium oxide (TiO₂), a glass material containing a hydroxyl group or a compound having a hydrophilic group is used. Note that titanium oxide has a property called superhydrophilicity upon receiving ultraviolet light. Superhydrophilicity is the property that a liquid contacts a solid at a contract angle as close to 0° as possible. When each hydrophilic region preferably has superhydrophilicity, the titanium oxide with which the inner surface of the cuvette is coated is preferably irradiated with ultraviolet light.

Note that it is possible to change the degree of hydrophilicity, i.e., the contact angle formed by a liquid, in accordance with the roughness of the surface of each hydrophilic region. For example, as the smoothness of the surface of each hydrophilic region is increased, the hydrophilicity of the hydrophilic region can be increased, that is, the contact angle can be decreased. Likewise, it is possible to change the degree of hydrophobicity, i.e., the contact angle formed by a liquid, in accordance with the roughness of the surface of each hydrophobic region. For example, as the roughness of the surface of each hydrophobic region is increased, the hydrophobicity of the hydrophobic region can be increased, that is, the contact angle can increased. The surface of each hydrophobic region is preferably roughened by sand blasting or the like.

In addition, the method of forming hydrophilic regions and hydrophobic regions is not limited to coating. For example, hydrophilic regions and hydrophobic regions may be formed by surface micropatterning. The micropatterns of hydrophilic regions and hydrophobic regions formed by the surface micropatterning include a line-and-space pattern and a pillar pattern. The micropatterns of hydrophilic regions and hydrophobic regions are formed by, for example, chemical or mechanical surface treatment technique.

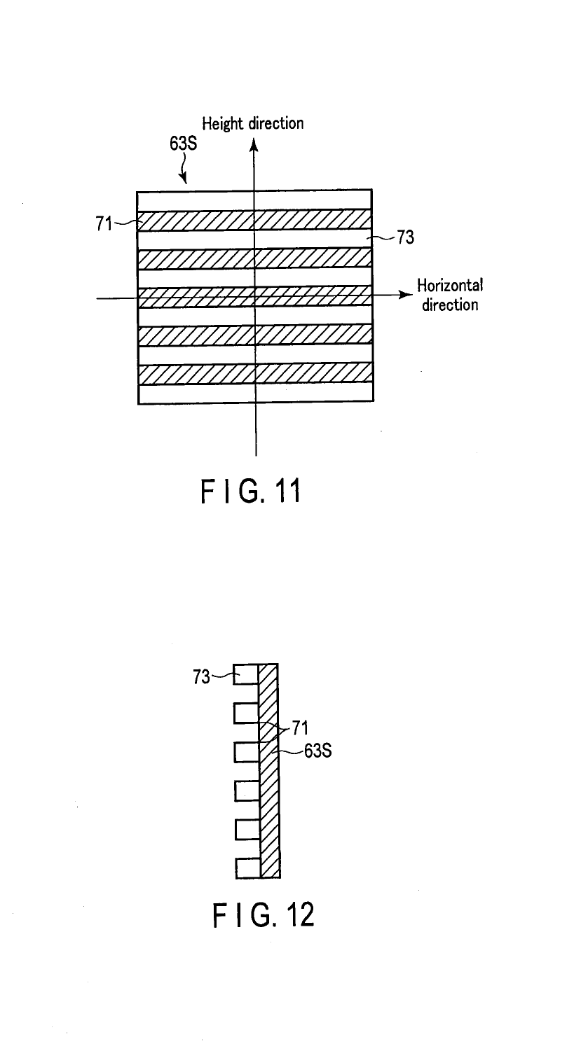

FIG. 11 is a plan view of a side wall inner surface 63s having a line-and-space pattern. FIG. 12 is a sectional view of the side wall inner surface taken along the height direction in FIG. 11. As shown in FIGS. 11 and 12, the hydrophilic regions 71 and the hydrophobic regions 73 have a line-and-space pattern. That is, concave portions are provided in the prospective formation regions of the hydrophilic regions 71 of the side wall inner surface 63s, and convex portions are provided on the prospective formation regions of the hydrophobic regions 73. When convex and concave portions are periodically formed on the order of μm, air tends to stay in the concave portions. When air stays in the concave portions, the side wall inner surface 63s exhibits hydrophobicity in the height direction. The side wall inner surface 63s does not have any periodic structure of convex and concave portions in the horizontal direction and has a convex or concave portion uniformly formed. For this reason, the side wall inner surface 63s exhibits hydrophilicity in the horizontal direction. Convex and concave portions may be formed from the same material as that for the cuvette 31 or a material different from that for the cuvette 31. In addition, convex and concave portions may be formed from the same material or different materials. If, for example, the cuvette 31 is formed from a hydrophilic material, convex portions are formed by patterning a hydrophobic material. Regions of the side wall inner surface 63s on which no convex portions are formed correspond to concave portions. Forming convex portions using a hydrophobic material in this manner can further enhance the hydrophobicity of the side wall inner surface 63s.

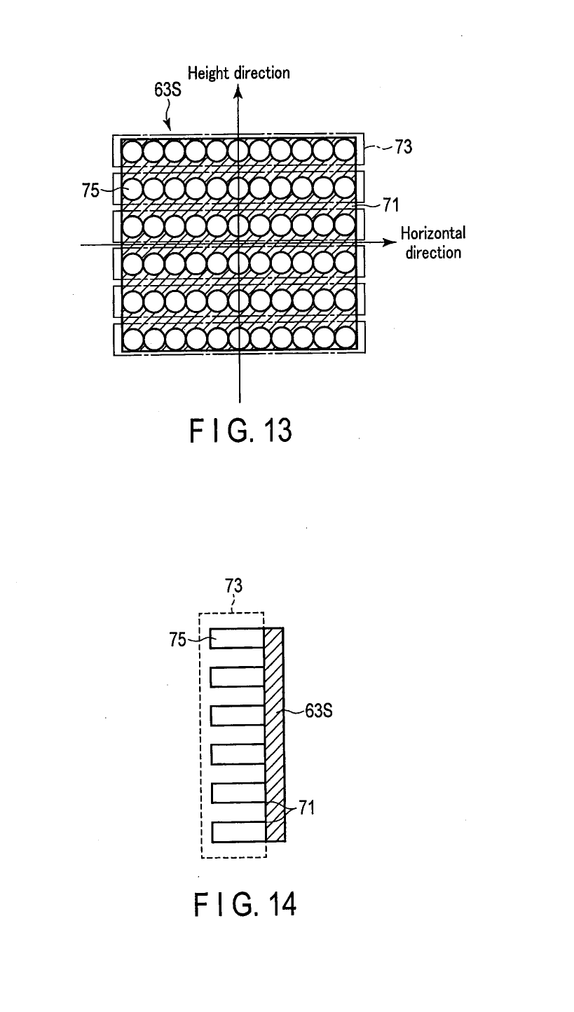

FIG. 13 is a plan view of the side wall inner surface 63s having a pillar pattern. FIG. 14 is a sectional view of the side wall inner surface taken along the height direction in FIG. 13. As shown in FIGS. 13 and 14, only the prospective formation regions of the hydrophobic regions 73 of the side wall inner surface 63s have a plurality of pillar structures 75. That is, the plurality of pillar structures 75 are arrayed in the horizontal direction. The density, height, and the like of the pillar structures 75 can be arbitrarily set. Each pillar structure 75 is a minute structure having a convex shape. More specifically, each pillar structure 75 is formed into a circular columnar shape. For example, the plurality of pillar structures 75 are densely formed in the prospective formation regions of the hydrophobic regions 73. The pillar structures 75 may be formed from the same material as that for the cuvette 31 or a material different from that for the cuvette 31. The pillar structures 75 may be formed from a hydrophobic material. Forming the pillar structures 75 using a hydrophobic material in this manner can further enhance the hydrophobicity of the hydrophobic regions 73. When the side wall inner surface 63s is dipped in a liquid, air bubbles tend to stay in the gaps between the plurality of pillar structures 75. The regions of the side wall inner surface 63s on which no pillar structures 75 are formed function as the hydrophilic regions 71.

According to the above description, the hydrophilic regions 71 and the hydrophobic regions 73 are provided along the horizontal direction. However, this embodiment is not limited to this. For example, the hydrophilic regions 71 and the hydrophobic regions 73 may be provided along a direction tilting from the horizontal direction at a predetermined angle. In addition, the shape of each pillar structure 75 is not limited to a circular columnar shape and may be a rectangular columnar shape.

The effect obtained by alternately arraying the hydrophilic regions 71 and the hydrophobic regions 73 according to this embodiment will be described next. As shown in FIG. 23, when a liquid is stirred in a cuvette whose entire side wall inner surfaces have hydrophilicity, the liquid creeps up toward the opening along the inner walls by a capillary action. As the liquid creeps up, the liquid level of a central portion relatively decreases, resulting in an increase in the tendency to form minute liquid droplets or air bubbles. These factors make it difficult to uniformly mix the liquid. In addition, as shown in FIG. 24, when a liquid is stirred in a cuvette whose entire side wall inner surfaces have hydrophobicity, although the creeping of the liquid is suppressed, minute liquid droplets or air bubbles tend to be formed. This is because the hydrophobic regions are isotopically distributed on the side wall inner surfaces. In addition, when the side wall inner surfaces have hydrophobicity, stirring tends to form air bubbles or minute liquid droplets. Furthermore, formed minute liquid droplets are scattered and adhere to the inner surface by stirring. This makes it difficult to uniformly mix the liquid.

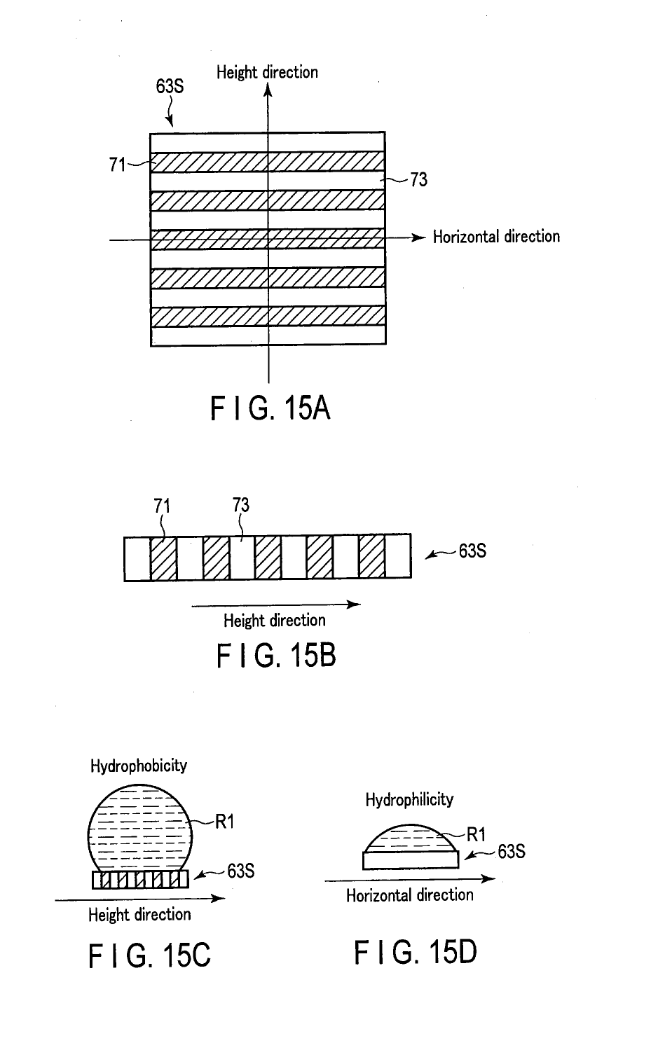

FIGS. 15A, 15B, 15C, and 15D are views for explaining the effects obtained by alternately arraying the hydrophilic regions 71 and the hydrophobic regions 73. FIG. 15A is a schematic plan view of the side wall inner surface 63S. FIG. 15B is a schematic sectional view of the side wall inner surface 63S in the height direction. FIG. 15C is a view showing the contact angle of a liquid adhering to the side wall inner surface 63S in the height direction. FIG. 15D is a view showing the contact angle of a liquid adhering to the side wall inner surface 63S in the horizontal direction. As shown in FIGS. 15A and 15B, the hydrophilic regions 71 and the hydrophobic regions 73 are alternately provided on the side wall inner surface 63s in the height direction. Alternately arraying the hydrophilic regions 71 and the hydrophobic regions 73 makes the contact angle of a liquid adhering to the side wall inner surface 63S have anisotropy. For example, as shown in FIG. 15C, since the hydrophilic regions 71 and the hydrophobic regions 73 are alternately provided on the side wall inner surface 63S in the height direction, the side wall inner surface 63S has hydrophobicity in the height direction. Since the side wall inner surface 63S has hydrophobicity in the height direction, it is possible to prevent a liquid from creeping up by a capillary action when stirred in the cuvette 31. In addition, as shown in FIG. 15D, since the hydrophilic regions 71 and the hydrophobic regions 73 are uniformly provided on the side wall inner surface 63S in the horizontal direction, the side wall inner surface 63S has hydrophilicity in the horizontal direction. Since the side wall inner surface 63S has hydrophilicity in the horizontal direction, a liquid which is suppressed from creeping up on the side wall inner surface 63S or minute liquid droplets contacting the side wall inner surface 63S flow in the horizontal direction. This makes it difficult for the liquid to adhere to the side wall inner surface 63S. In this manner, the cuvette 31 according to this embodiment makes the contact angle of a liquid contacting the side wall inner surface 63S have anisotropy, it is possible to prevent the formation of air bubbles or minute liquid droplets by stirring and the adhesion of the air bubbles or minute liquid droplets to the side wall inner surface 63S while suppressing the creeping of the liquid along the side wall inner surface 63S.

In addition, if a hydrophobic region is provided on the bottom surface, since a liquid is sucked to the side wall inner surfaces, the bottom surface may be exposed when the amount of liquid is small. The bottom surface 61S of the bottom wall 61 according to this embodiment is provided with the hydrophilic region 71. If the bottom surface 61S is provided with the hydrophilic region 71, since a liquid is uniformly distributed on the bottom surface 61S, the bottom surface 61S is not easily exposed even if the amount of liquid is small. According to the embodiment, therefore, it is possible to uniformly mix a liquid in the cuvette 31 as compared with a case in which the bottom surface 61S has hydrophobicity, even if the amount of liquid is small.

As described above, the cuvette 31 according to this embodiment has the bottom wall 61 having the bottom surface 61S and side walls 63 connected to the bottom wall 61 so as to surround the bottom surface 61S. The side wall inner surfaces 63S of the side wall 63 are alternately provided, in the height direction, with hydrophilic regions 71, each having the first contact angle with respect to a liquid contained in the cuvette 31, and the hydrophobic regions 73, each having the second contact angle larger than the first contact angle. Since the amounts of liquid contained in the cuvettes 31 differ from each other, the liquid levels of liquids sometimes vary. However, alternately arraying the hydrophilic regions 71 and the hydrophobic regions 73 on the side wall inner surfaces 63S makes it possible to prevent the generation of air bubbles or minute liquid droplets by stirring and the adhesion of the air bubbles or minute liquid droplets to the side wall inner surfaces 63s while suppressing the creeping of the liquid along the side wall inner surfaces 63S regardless of the amount of liquid. Consequently, according to this embodiment, it is possible to more uniformly mix a liquid in the cuvette 31 than in the related art, in which only hydrophilic regions or hydrophobic regions are provided on the entire side wall inner surfaces.

Various application examples according to this embodiment will be described next.

### Application Example 1

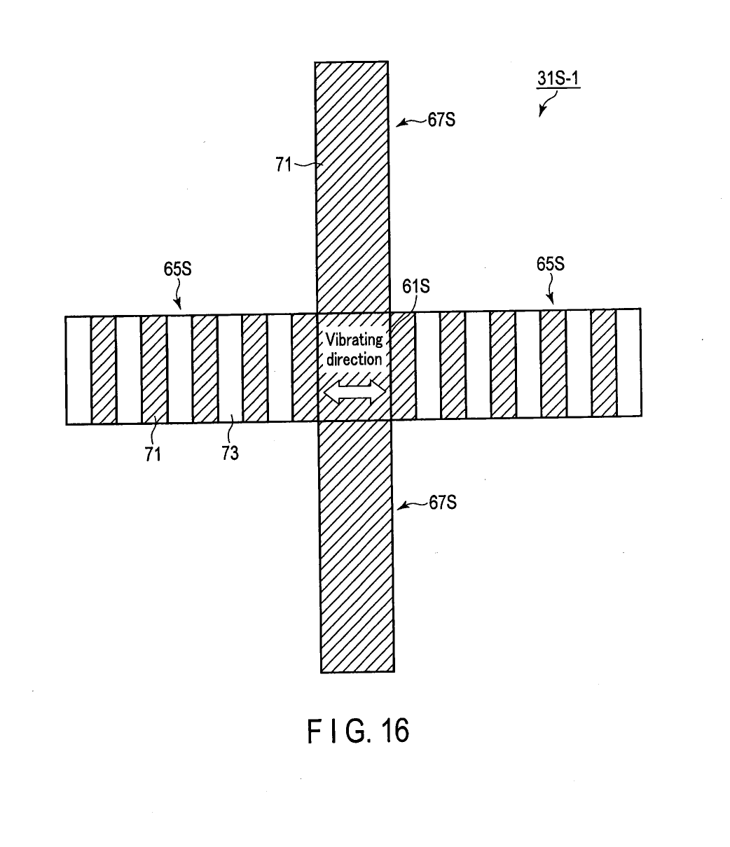

FIG. 16 is a development view of inner surfaces 31s-1 of the cuvette 31 according to application example 1. As shown in FIG. 16, the cuvette 31 according to application example 1 has the hydrophilic regions 71 and the hydrophobic regions 73 alternately provided, in the height direction, on the two large inner surfaces 65S perpendicular to the vibrating direction of the blade 55, and has the hydrophilic regions 71 provided on the two small inner surfaces 67S parallel to the vibrating direction.

The large inner surfaces 65S are perpendicular to the vibrating direction, and hence a wavy liquid tends to collide with the large inner surfaces 65S because of the vibration of the blade 55, as compared with the small inner surfaces 67S. For this reason, a liquid tends to creep up on the large inner surfaces 65S as compared with the small inner surfaces 67S. It is possible to suppress the creeping of a liquid along the large inner surfaces 65S along with stirring by alternately providing the hydrophilic regions 71 and the hydrophobic regions 73 in the height direction on the large inner surfaces 65S. In addition, since each hydrophilic region 71 is vertically sandwiched between the hydrophobic regions 73 on the large inner surfaces 65S, liquid droplets adhering to the hydrophilic regions 71 flow in the horizontal direction to the small inner surfaces 67S. As described above, the hydrophilic regions 71 are provided on the entire surfaces of the small inner surfaces 67S. For this reason, the small inner surfaces 67S having the hydrophilic regions 71 can make liquid droplets flowing from the large inner surfaces 65S flow downward. In addition, since the hydrophilic regions 71 are provided on the entire surfaces of the small inner surfaces 67S, a liquid which has directly collided with the small inner surfaces 67S because of the vibration or the like of the blade 55 flows downward. As the liquid flows downward, a recess in the central portion of the liquid, which is formed along with stirring, is eliminated. This makes it possible to improve faulty stirring caused by the recess in the central portion.

As described above, the cuvette 31 according to application example 1 can improve faulty stirring caused by the recess in the central portion of a liquid, which is formed by stirring; while suppressing the creeping of the liquid along the side wall inner surfaces 65s. As compared with the related art, therefore, a liquid can be quickly and uniformly mixed. Note that the creeping of a liquid more easily occurs on the side wall inner surfaces perpendicular to the vibrating direction than on the side wall inner surfaces parallel to the vibration direction. Therefore, in order to maximize the effects of suppressing the creeping of a liquid and eliminating the recess in the central portion of the liquid, it is preferable to arrange the cuvette 31 according to application example 1 in the reaction disk 11 so as to make the large-area side walls 65, on which the hydrophilic regions and the hydrophobic regions are alternately provided, become perpendicular to the vibrating direction.

Note that in the above description, the side walls alternately provided with the hydrophilic regions 71 and the hydrophobic regions 73 are two side walls facing each other. However, this embodiment is not limited to this. For example, the hydrophilic regions 71 and the hydrophobic regions 73 may be alternately provided on two adjacent side walls. In addition, the side walls alternately provided with the hydrophilic regions 71 and the hydrophobic regions 73 are not limited to two side walls of the fourth side walls. That is, such regions may be provided on three side walls or one side wall. The side wall inner surfaces which are not alternately provided with the hydrophilic regions 71 and the hydrophobic regions 73 may be provided with the hydrophilic regions 71 to make liquid droplets adhering to the side wall inner surfaces flow downward.

### Application Example 2

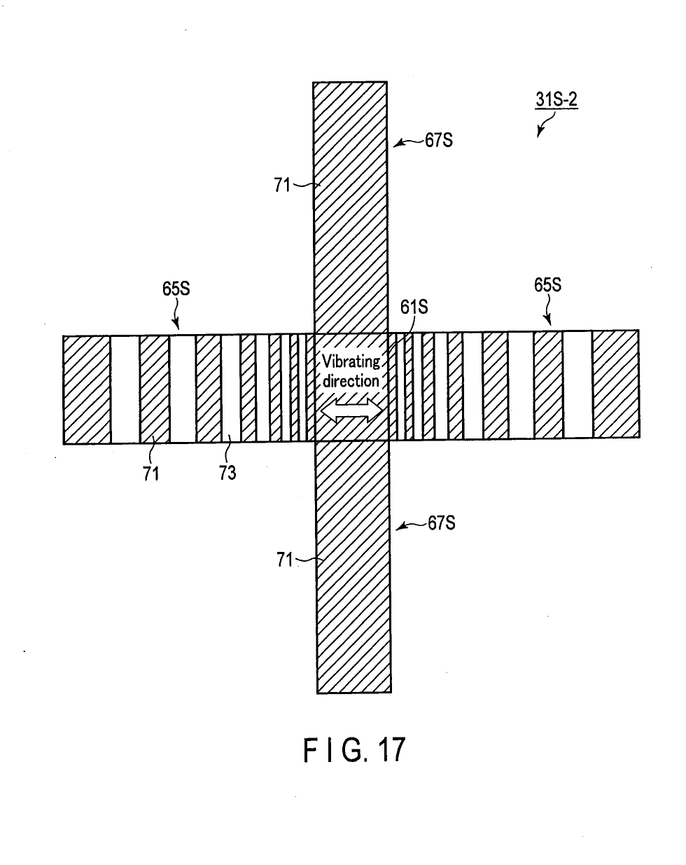

FIG. 17 is a development view of inner surfaces 31S-2 of the cuvette 31 according to application example 2. As shown in FIG. 17, like the cuvette 31 according to application example 1, the cuvette 31 according to application example 2 has the hydrophilic regions 71 and the hydrophobic regions 73 alternately provided on the two large inner surfaces 65S in the height direction, and has the hydrophilic regions 71 provided on the two small inner surfaces 67S. In application example 2, the hydrophilic regions 71 and the hydrophobic regions 73 are provided such that the widths of the hydrophilic regions 71 and the hydrophobic regions 73 gradually increase from the bottom surface 61S to the opening in the height direction. The degree of increase in width can be arbitrarily set.

As described above, since the amount of liquid to be stirred is not constant, the liquid levels of liquids in a plurality of cuvettes 31 vary. The smaller the amount of liquid, the lower the height the liquid creeps up. If the width of the hydrophilic region 71 and the hydrophobic region 73 is too large as compared with the height by which a liquid creeps up, the effect of suppressing the creeping of a liquid cannot be obtained. In contrast to this, if the width of the hydrophilic region 71 and the hydrophobic region 73 is too small as compared with the height by which a liquid creeps up, the creeping of a liquid is excessively suppressed. This makes it easy to generate air bubbles or minute liquid droplets. As a method of simultaneously solving the two problems, there is conceivable a method of switching between the vibration modes of the blade in accordance with the amount of liquid. However, a mechanism having a plurality of vibration modes is complicated and expensive.

In the cuvette 31 according to application example 2, the widths of the hydrophilic regions 71 and the hydrophobic regions 73 gradually decrease toward the bottom surface 61S of the cuvette 31, and gradually increase toward the opening. Therefore, it is possible to properly suppress the creeping of a liquid by a capillary action in accordance with the amount of liquid while preventing the generation of air bubbles or minute liquid droplets without switching between the vibration modes of the blade 55.

### Application Example 3

The cuvette 31 according to application example 3 will be described below. Note that the same reference numerals as in this embodiment denote constituent elements having almost the same functions in the following description, and a repetitive description will be made only when required.

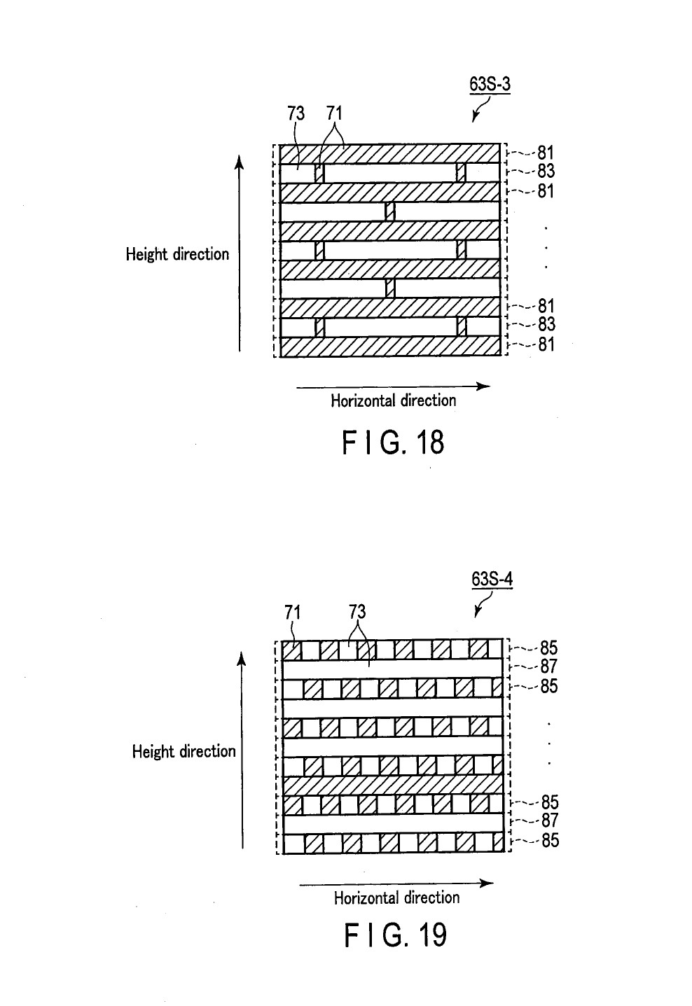

FIG. 18 is a view schematically showing one side wall inner surface 63S-3 of a cuvette 61 according to application example 3. As shown in FIG. 18, the side wall inner surface 63S-3 is alternately provided, in the height direction, with first inner surface regions 81 and second inner surface regions 83, each having a linear shape. The first inner surface regions 81 and the second inner surface regions 83 are provided parallel to the horizontal direction. The hydrophilic regions 71 are provided in the first inner surface regions 81. In addition, the hydrophilic regions 71 are locally provided in the second inner surface regions 83 to connect the bottom surface to the opening via the hydrophilic regions 71. The hydrophilic regions 71, each having a linear shape, in the first inner surface regions 81 are connected to each other via the local hydrophilic regions 71 in the second inner surface regions 83. As shown in FIG. 18, it is preferable to alternately provide the local hydrophilic regions 71 in the second inner surface regions 83 instead of arranging the hydrophilic regions 71 on straight lines. In other words, the local hydrophilic regions 71 in the second inner surface regions 83 are preferably arranged at positions different in the horizontal direction from those of the local hydrophilic regions 71 in the second inner surface regions 83 adjacent to the second inner surface regions 83. The hydrophobic regions 73 are provided in inner surface regions, of the second inner surface regions 83, which are located other than local hydrophilic regions 71. In this manner, the hydrophilic regions 71 and the hydrophobic regions 73 are alternately provided in the height direction, and the hydrophilic regions 71 are seamlessly distributed in the height direction from the bottom surface to the opening, thereby making liquid droplets adhering to the side wall inner surface 63S-3 flow downward while suppressing the creeping of a liquid by a capillary action.

Note that an array pattern of the hydrophilic regions 71 and the hydrophobic regions 73, which is indicated by the side wall inner surface 63S-3 described above, may be provided on the inner surface of any side wall 61 of the four side walls 61 included in the cuvette 31.

### Application Example 4

The cuvette 31 according to application example 4 will be described below. Note that the same reference numerals as in this embodiment denote constituent elements having almost the same functions in the following description, and a repetitive description will be made only when required.

FIG. 19 is a view schematically showing one side wall inner surface 63S-4 of the cuvette 31 according to application example 4. As shown in FIG. 19, first inner surface regions 85 and second inner surface regions 87, each having a linear shape, are alternately provided on the side wall inner surface 63S-4 in the height direction. The first inner surface regions 85 and the second inner surface regions 87 are provided parallel to the horizontal direction. The hydrophobic regions 73 are provided in the second inner surface regions 87. The hydrophilic regions 71 and the hydrophobic regions 73 are alternately provided in the first inner surface regions 85. For example, it is preferable to alternately provide the hydrophilic regions 71 in the height direction. In other words, the hydrophilic regions 71 are preferably arranged at positions different in the horizontal direction from those of the local hydrophilic regions 71 in the first inner surface regions 85 adjacent to the first inner surface regions 85.

An array pattern of the hydrophilic regions 71 and the hydrophobic regions 73 according to application example 4 can enhance hydrophilicity in the horizontal direction as compared with a case in which the hydrophobic region 73 is entirely provided on the side wall inner surface. That is, the first inner surface regions 85 alternately provided with the hydrophilic regions 71 and the hydrophobic regions 73 in the horizontal direction and the second inner surface regions 87 provided with the hydrophobic regions 73 are alternately provided in the height direction, thereby suppressing the adhesion of a liquid to the side wall inner surface 63S-4 while suppressing the creeping of a liquid by a capillary action.

### Application Example 5

The cuvette 31 according to application example 5 will be described below. Note that the same reference numerals as in this embodiment denote constituent elements having almost the same functions in the following description, and a repetitive description will be made only when required.

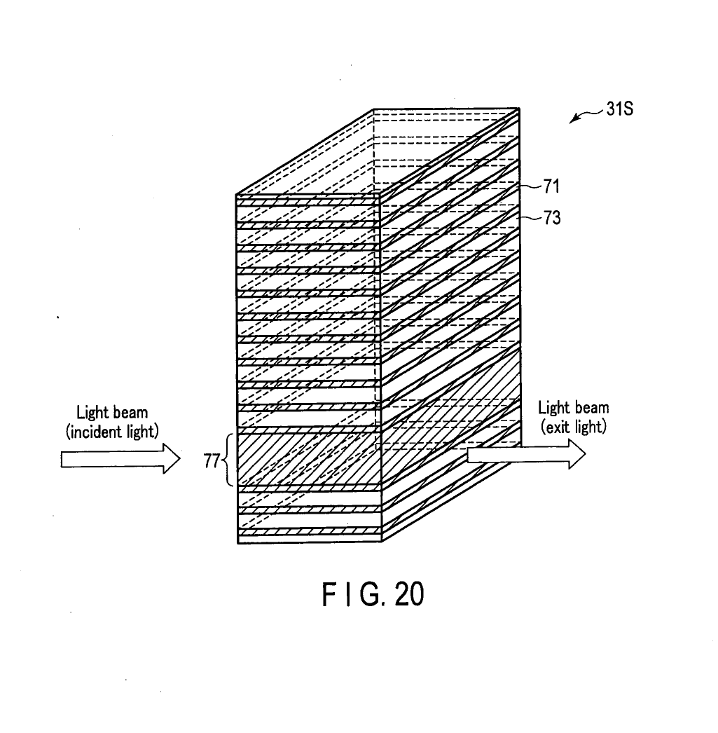

FIG. 20 is a view schematically showing the positional relationship between the cuvette 31 according to application example 5 and the light beam emitted from the optical measurement unit 25. As shown in FIG. 20, after the stirring of a reaction liquid, the reaction disk 11 pivots so as to make the cuvette 31 cross the light beam emitted at a photometry position for optical measurement. If the hydrophilic regions 71 and the hydrophobic regions 73 exist together in the transmission path of a light beam, this adversely affects optical measurement. It is, therefore, preferable not to perform a process for the formation of hydrophilic regions or hydrophobic regions in a portion (to be referred to as a transmission portion hereinafter) 77, of the inner surface 31S, which corresponds to the transmission path of the light beam. The range of the transmission portion 77 in the inner surface 31S is positioned in accordance with the height of the light beam emitted from the optical measurement unit 25 with respect to the installation surface of the cuvette 31. If, for example, the cuvette 31 itself has hydrophilicity, it is preferable not to form the hydrophobic regions 73 in the transmission portion 77, as shown in FIG. 20. In contrast to this, if the cuvette 31 itself has hydrophobicity, it is preferable not to form the hydrophilic regions 71 in the transmission portion 77.

According to application example 5, it is possible to prevent a deterioration in the accuracy of optical measurement.

### (Modification 1)

According to the above embodiment, the side wall 63 of the cuvette 31 has a rectangular cylindrical shape. However, this embodiment is not limited to this. The cuvette 31 according to the embodiment can be applied to any existing shape. The cuvette 31 according to a modification of the embodiment will be described below. Note that the same reference numerals as in this embodiment denote constituent elements having almost the same functions in the following description, and a repetitive description will be made only when required.

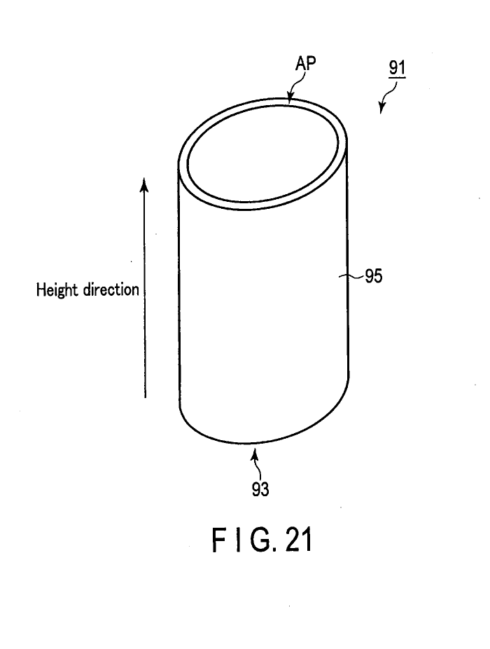

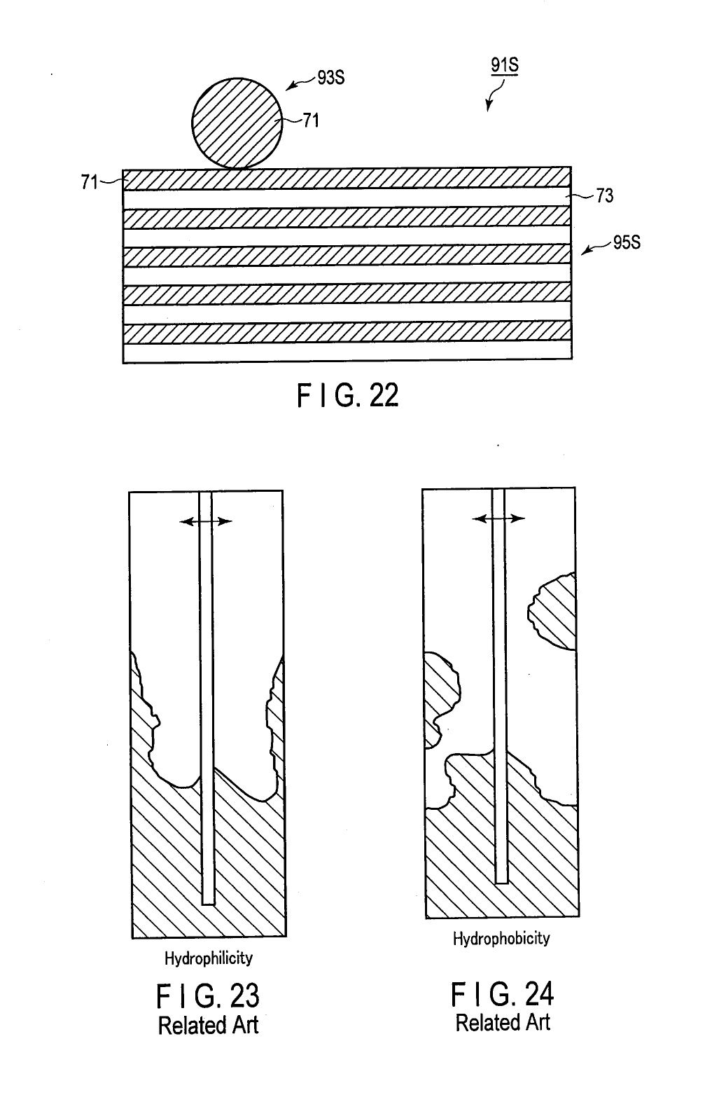

FIG. 21 is a perspective view showing the outer appearance of a cuvette 91 according to modification 1. As shown in FIG. 21, the cuvette 91 according to modification 1 has a bottom wall 93 having a circular shape and a side wall 95 having a circular cylindrical shape. The bottom wall 93 may have a true circular shape or elliptic shape. FIG. 22 is a development view of an inner surface 91S of the cuvette 91 according to modification 1. As shown in FIG. 22, the hydrophilic regions 71 and the hydrophobic regions 73 are alternately provided in the height direction on a side wall inner surface 95s of the cuvette 91 according to modification 1. The width of each of the hydrophilic regions 71 and that of each of the hydrophobic regions 73 may be set constantly in the height direction or may be set to gradually increase from the bottom surface to the opening as in application example 2. The hydrophilic region 71 is preferably provided on a bottom surface 93s of the cuvette 91 to improve the stirring efficiency when the amount of liquid is small.

According to modification 1, therefore, even the cuvette 91 having a circular cylindrical shape can prevent the generation of air bubbles or minute liquid droplets by stirring and the adhesion of the air bubbles or minute liquid droplets to the side wall inner surface 73S while suppressing the creeping of the liquid along the side wall inner surface 95S, regardless of the amount of liquid, by alternately providing the hydrophilic regions 71 and the hydrophobic regions 73 in the height direction on the side wall inner surface 95S. This makes it possible to more uniformly mix a liquid in the cuvette 91.

### (Modification 2)

According to the above embodiment, the stirring unit 23 is configured to stir a liquid in the cuvette 31 or 91 by reciprocating the blade 55. However, this embodiment is not limited to this. The stirring mode of the stirring unit 23 according to the embodiment can be applied to any existing modes. For example, the stirring unit 23 may stir a liquid by rotating the blade 55 having a paddle mounted on its distal end portion about the main shaft of the blade 55. The cuvettes 31 and 91 according to these modifications can have the same effects as those of the embodiment described above, regardless of the stirring mode, by alternately providing the hydrophilic regions 71 and the hydrophobic regions 73 in the height direction on the inner surfaces 31S and 91S.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A cuvette comprising:
a bottom wall having a bottom surface; and
a side wall connected to the bottom wall to surround the bottom surface,
wherein an inner surface of the side wall is alternatively provided, in a long axis direction of the side wall, first contact angle regions, each having a first contact angle with respect to a liquid, and second contact angle regions, each having a second contact angle larger than the first contact angle.

2. The cuvette of claim 1, wherein the side wall has a rectangular cylindrical shape, and
the first contact angle regions and the second contact angle regions are alternately provided in the long axis direction on each of inner surfaces of a first side wall and a second side wall, of four side walls constituting the side wall, which face each other.

3. The cuvette of claim 2, wherein the first contact angle regions are provided on each of inner surfaces of a third side wall and a fourth side wall, of the four side walls, which are perpendicular to the first side wall and the second side wall, respectively.

4. The cuvette of claim 1, wherein the first contact angle regions and the second contact angle regions are provided on the side wall such that widths of the first contact angle regions and the second contact angle regions gradually increase from the bottom wall to the opening.

5. The cuvette of claim 1, wherein the first contact angle region is provided on the bottom surface.

6. The cuvette of claim 1, wherein the side wall has a circular cylindrical shape.

7. The cuvette of claim 1, wherein the first contact angle region has hydrophilicity, and the second contact angle region has hydrophobicity.

8. The cuvette of claim 1, wherein first inner surface regions and second inner surface regions, each having a strip shape, are alternately provided in the long axis direction on the inner surface of the side wall,
the first contact angle regions are provided in the first inner surface regions, and
the second contact angle regions are provided in the second inner surface regions.

9. The cuvette of claim 8, wherein the first contact angle regions are locally provided in the second inner surface regions in addition to the second contact angle regions to connect the first contact angle regions from the bottom wall to the opening.

10. The cuvette of claim 8, wherein the first contact angle regions and the second contact angle regions are alternately provided in a direction perpendicular to the long axis direction in the first inner surface regions.

11. The cuvette of claim 1, wherein the first contact angle region is formed from at least one material selected from the group consisting of titanium oxide, a glass material containing a hydroxyl group, and a compound having a hydrophilic group.

12. The cuvette of claim 1, wherein the second contact angle region is formed from at least one material selected from the group consisting of a fluorine compound, octadecyltrichlorosilane, silicone resin, paraffin, and a compound having a hydrophobic group.

13. The cuvette of claim 1, wherein the first contact angle region is formed from the same material as that for the side wall.

14. The cuvette of claim 1, wherein the second contact angle region is formed by forming a micropattern on the inner surface of the side wall.

15. The cuvette of claim 1, wherein only one of the first contact angle region and the second contact angle region is provided on a light transmission portion, of the inner surface of the side wall, which is used for optical measurement.

16. An automatic analyzer comprising:
a cuvette holding mechanism configured to hold a plurality of cuvettes;
a stirring mechanism configured to stir a liquid contained in the plurality of cuvettes; and
an optical measurement unit configured to optically measure a component of the liquid contained in the plurality of cuvettes,
wherein the cuvette comprises a bottom wall having a bottom surface, and a side wall connected to the bottom wall so as to surround the bottom surface, and an inner surface of the side wall is alternatively provided, in a long axis direction of the side wall, first contact angle regions, each having a first contact angle with respect to a liquid, and second contact angle regions, each having a second contact angle larger than the first contact angle.
